(19) United States
(12) Patent Application Publication
(10) Pub. No.: US 2006/0120836 A1
(43) Pub. Date: Jun. 8, 2006

(54) Bag lift for an air seeder tank

(75) Inventors: Mark Cresswell, St. Brieux (CA); Scot Jagow, St. Brieux (CA)

Correspondence Address: FROST BROWN TODD, LLC, 2200 PNC CENTER, 201 E. FIFTH STREET, CINCINNATI, OH, 45202, US

(73) Assignee: Bourgault Industries Ltd.

(21) Appl. No.: 11/005,084

(22) Filed: Dec. 6, 2004

(51) Int. Cl. A01C 7/00; A01C 9/00; B65F 9/00; B65G 67/00

(52) U.S. Cl. 414/334

(57) ABSTRACT

An agricultural air seeder apparatus adapted for loading bagged agricultural products comprises an air seeder with a tank having a top fill hatch. A platform is adapted to carry a plurality of bags of agricultural product, and a raising mechanism is attached to the air seeder and the platform and is operative to move the platform from a lowered vertical position for loading with bags, to a raised vertical position adjacent to the top fill hatch while maintaining the platform in a substantially horizontal orientation. A box with fold down and removable sides can be provided on the platform.

This invention is in the field of agricultural air seeders, and in particular mechanisms for transferring agricultural product into the tanks of an air seeder.

### BACKGROUND OF THE INVENTION

Agricultural air seeders have one or more tanks for carrying agricultural product that is to be deposited on a field. Such tanks are commonly carried on a cart pulled either behind or ahead of a ground engaging implement, although on occasion the tanks are mounted directly on the implement. Typically, a conveyor with an intake hopper is mounted on the air seeder for receiving agricultural product from a transport vehicle and transferring it into the tanks. Although belt conveyors are known, these tank filling conveyors are most commonly auger conveyors.

These filling conveyors are designed to efficiently transfer large volumes of bulk agricultural product at high rates. When using an auger conveyor there is always product remaining in the conveyor after the filling event, and typically two or more different products are loaded into separate tanks with the same conveyor. Depending on the products and the situation, it is often desired that the products not be mixed by conveying the second product through the conveyor and thus carrying a remaining first product into the second product tank. To prevent such mixing when switching from one agricultural product to the other, the auger conveyor is reversed and the intake hopper is rotated on the tube such the remaining product is emptied from the conveyor tube and falls onto the ground. As air seeders have become larger, the conveyors have also become larger in diameter and length, such that the amount of product emptied from them after filling can be significant.

Depending on the value of the product, and the degree of urgency of the operator to complete the seeding task, this emptied material may be simply dumped on the ground and wasted, or received in a container and returned to the transport vehicle or carried up to the top hatch of the air seeder tank. With the large size of present day trucks and air seeder tanks, this is generally a hazardous, onerous and physically demanding task, with the result that even though the waste amount is economically significant, often the operator leaves the product on the ground instead of saving it. Alternatively, the product can be left in the container and used in the next filling event, however there is typically no convenient place to store or carry the filled or partially filled container when moving to the next filling event.

Many agricultural products, such as canola seed or inoculants, are applied at much lower rates than other agricultural products, such as wheat seed and fertilizer. These lower rate agricultural products are typically relatively expensive per pound, and are typically handled in small containers, commonly bags, that can be handled manually rather than in bulk.

Use of the conventional air seeder filling conveyor with smaller volumes of bagged agricultural product such as canola seed or inoculants is problematic. It can be cumbersome and inefficient to empty the bags into the large conveyor to load the product into the tank, especially when quite often only a few bags are loaded into the tank at any one filling event. The amount of bagged agricultural product that must be placed into an auger conveyor hopper before the auger begins to engage and load the product is typically quite large compared to the total amount of bagged product to be loaded into an air seeder cart tank per filling event. Thus the amount of bagged product that must be removed from the auger and auger hopper is relatively large compared to the amount that is actually loaded into the tank per filling event. The product that must be removed is also relatively expensive, and so when reversing to clean the auger conveyor, the remaining product must be caught in a container and either carried to the top of the seeder to dump into the tank, or left in a container to be used at the next filling event.

Instead of using the air seeder conveyor, these bagged agricultural products are often carried or thrown up and onto the top of the tank and dumped into the tank manually. This manual loading is physically very demanding and exposes the person loading the bagged product to risk of injury. Air seeder tanks can be quite high, and often the bags are thrown up onto a catwalk, and then lifted from the catwalk to the top of the tank. The bags may be damaged or even split open during such handling. Such manual loading is quite time-consuming, labor intensive, and requires that the operator be physically fit or may require a second person's assistance.

Similarly, during a typical air seeder calibration, considerable agricultural product will be fed from the metering devices of the air seeder into calibration boxes and then weighed to accurately determine the application rate of each metering device. As above, the calibration boxes must then be carried up and emptied into the tanks, returned to the transport vehicle, or kept to be used at a later filling event.

In order to reduce the manual effort required to carry bags to the top fill hatch for emptying, crane devices, such as generally disclosed in U.S. Pat. No. 4,419,038 to Pendergraft, have been mounted on implements and used to lift bags up for emptying into agricultural product tanks. Each bag is attached to a hook or the like on the end of a cable, and then winched up and swung over the fill hatch of the tank.

### SUMMARY OF THE INVENTION

It is an object of the present invention to provide an apparatus that overcomes problems in the prior art of transferring agricultural products from a transport vehicle into an air seeder tank.

The present invention provides, in one embodiment, an agricultural air seeder apparatus adapted for loading containers of agricultural products. The apparatus comprises an air seeder having at least one tank mounted thereon, the at least one tank having a top fill hatch for filling the tank with an agricultural product. A platform is adapted to carry a plurality of containers of agricultural product and a raising mechanism is attached to the air seeder and the platform and is operative to move the platform from a lowered vertical position to a raised vertical position adjacent to the top fill hatch while maintaining the platform in a substantially horizontal orientation.

In a second embodiment the invention provides an agricultural air seeder cart apparatus adapted for loading bagged agricultural products. The apparatus comprises a cart having at least one tank mounted thereon, the tank having a top fill hatch for filling the tank with an agricultural product. A platform is adapted to carry a plurality of bags of agricultural product, and a parallel arm assembly is pivotally attached at a first end thereof to the cart and pivotally attached at an opposite second end thereof to the platform. An extendable actuator is pivotally attached to the cart and pivotally attached to the arm assembly and is operative to move the platform from a lowered vertical position in proximity to the ground to a raised vertical position adjacent to the top fill hatch. The parallel arm assembly maintains the platform in a substantially horizontal orientation as the platform moves from the lowered vertical position to the raised vertical position.

The platform conveniently comprises end and side walls forming a box to keep the containers, typically bags, in place. The side walls can be configured to fold down or be removed to facilitate access and lifting larger loads.

The platform and raising mechanism can be oriented so that the platform can be positioned at the same height as the floor of a truck box, so that the truck can be backed up to the platform and bags can be easily transferred from the truck box to the platform. Typically the actuator will be a hydraulic cylinder attached to the parallel arm assembly and operated by a control adjacent to air seeder.

A transport lock can be provided to lock the platform at an intermediate vertical position for transport. In addition to transferring agricultural products, the platform can act as a temporary storage place for bags of agricultural products to be used later if required when the air seeder is at a location in the field remote from transport vehicles carry the required agricultural products. A storage compartment can be provided under the platform for convenient storage of calibration boxes, agricultural product containers, and the like.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of the invention wherein the raising mechanism comprises a parallel arm assembly and showing the platform in the lowered vertical position;

FIG. 2 is a perspective view of the embodiment of FIG. 1 showing the platform in the raised vertical position;

FIG. 3 is a perspective view of the embodiment of FIG. 1 showing the platform in the intermediate vertical position;

FIG. 4 is a perspective view of the platform, raising mechanism, and transport lock of the embodiment of FIG. 1;

FIG. 5 is a front view of the pin hole defined by the lock bracket of the embodiment of FIG. 1;

FIG. 6 is a perspective view of the platform of the embodiment of FIG. 1;

FIG. 6A is a perspective view of the lower slot in the end walls, and the release notches of the platform of FIG. 6;

FIG. 6B is a perspective view of the upper slot in the end walls of the platform of FIG. 6;

FIG. 7 is a perspective view of an alternate upper slot in the end walls;

FIG. 8 is a perspective view of an alternate embodiment of the invention wherein the raising mechanism comprises an upright mast and an actuator.

### DETAILED DESCRIPTION OF THE ILLUSTRATED EMBODIMENTS

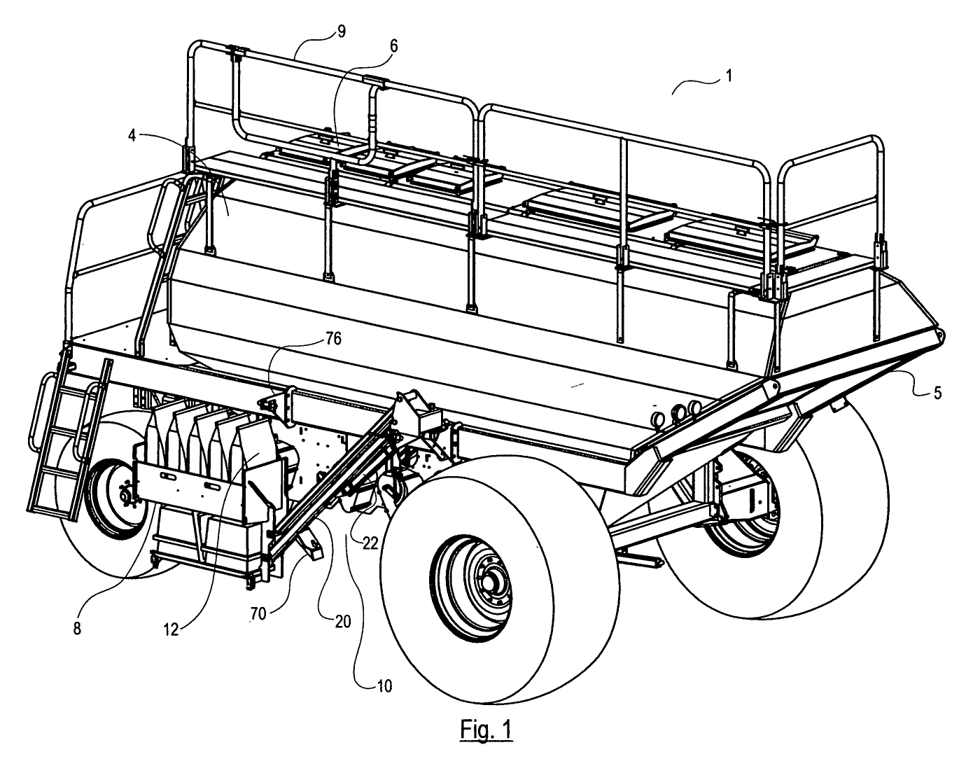

FIGS. 1-3 illustrate an agricultural air seeder cart apparatus 1 of the invention adapted for loading containers of agricultural products. The apparatus 1 comprises a cart 5 and a plurality of tanks 4 mounted thereon, each tank 4 having a top fill hatch 6 for filling the tank 4 with an agricultural product. Typically a filling conveyor is also mounted on the opposite side of the cart 5 for transferring bulk agricultural products from a transport vehicle to the top filling hatch 6 to fill the tanks 4 with appropriate agricultural products.

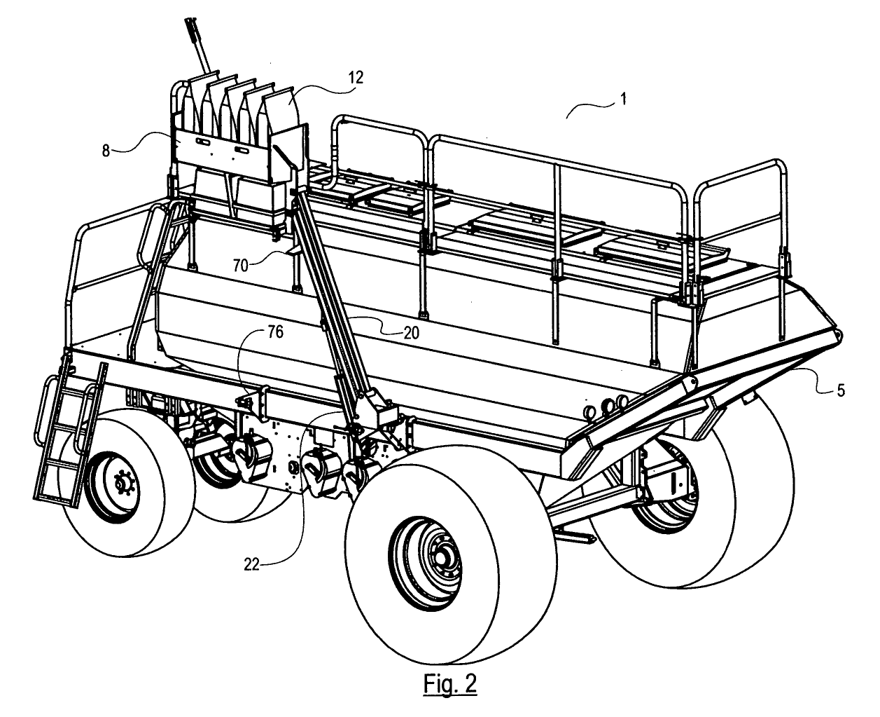

The present invention provides a platform 8 adapted to carry a plurality of agricultural product containers, illustrated as bags 12, and a raising mechanism 10 attached to the cart 5 and the platform 8 and operative to move the platform 8 from a lowered vertical position, as illustrated in FIG. 1, to a raised vertical position adjacent to the top fill hatches 6, illustrated in FIG. 2, while maintaining the platform 8 in a substantially horizontal orientation. Thus instead of dumping the bags 12 into the conventional filling conveyor to load same into the tanks 4, the bags 12 can be conveniently moved from a truck bed onto the platform 8 and raised to the level of the fill hatches 6, and then dumped directly into the desired tank 4 through the fill hatch 6. A section of the safety railing 9 on the top of the cart 5, as seen in FIG. 1, is removable as illustrated in FIG. 2, to facilitate access to the bags 12 on the raised platform 8.

The illustrated embodiment shows the tanks 4 mounted on a cart 5 that is towed ahead of or behind a ground engaging seeding implement, as is common in the air seeder field. Air seeders are also known where the tanks 4 are mounted directly on a seeding implement, and in such air seeders the raising mechanism 10 would be attached to the seeding implement

In the embodiment illustrated in FIGS. 1-4, the raising mechanism 10 comprises a parallel arm assembly 20 and an extendable actuator 22 attached between the cart 5 and the arm assembly 20.

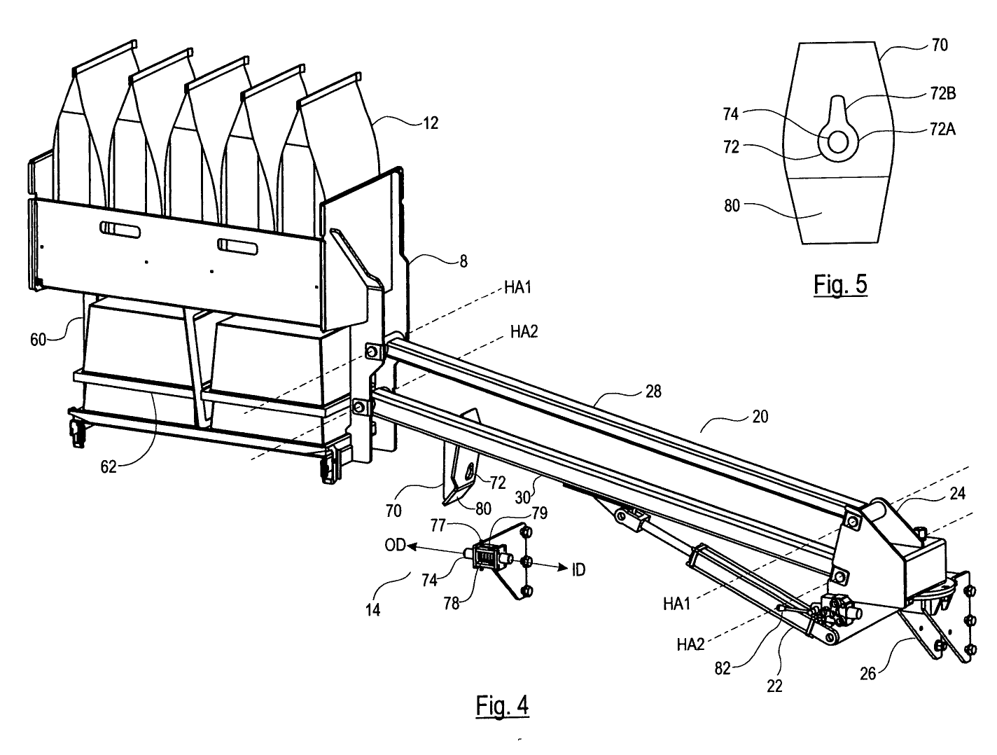

The parallel arm assembly 20 comprises, as best illustrated in FIG. 4, a base bracket 24 and a cart bracket 26. The cart bracket 26 is fixed to the cart 5, and the base bracket 24 is fixed to the cart bracket 26. An upper arm 28 is pivotally attached at opposite ends thereof to the base bracket 24 and to the platform 8 about substantially parallel and horizontal first axes HA1. A lower arm 30 is pivotally attached at opposite ends thereof to the base bracket 24 and the platform 8 about substantially horizontal second axes HA2 located equal distances below and parallel to the first axes HA1. The extendable actuator 22 is conveniently pivotally attached to the lower arm 30 and the base bracket 24.

It is contemplated that the parallel arm assembly 20 could also be configured to swing laterally with respect to the cart 5, however the illustrated embodiment where the parallel arm assembly 20 can only move up and down, and is fixed laterally, avoids problems of maneuvering the platform on uneven ground. The transport vehicle carrying containers of agricultural products to the air seeder can generally be maneuvered to a position adjacent to the platform without difficulty.

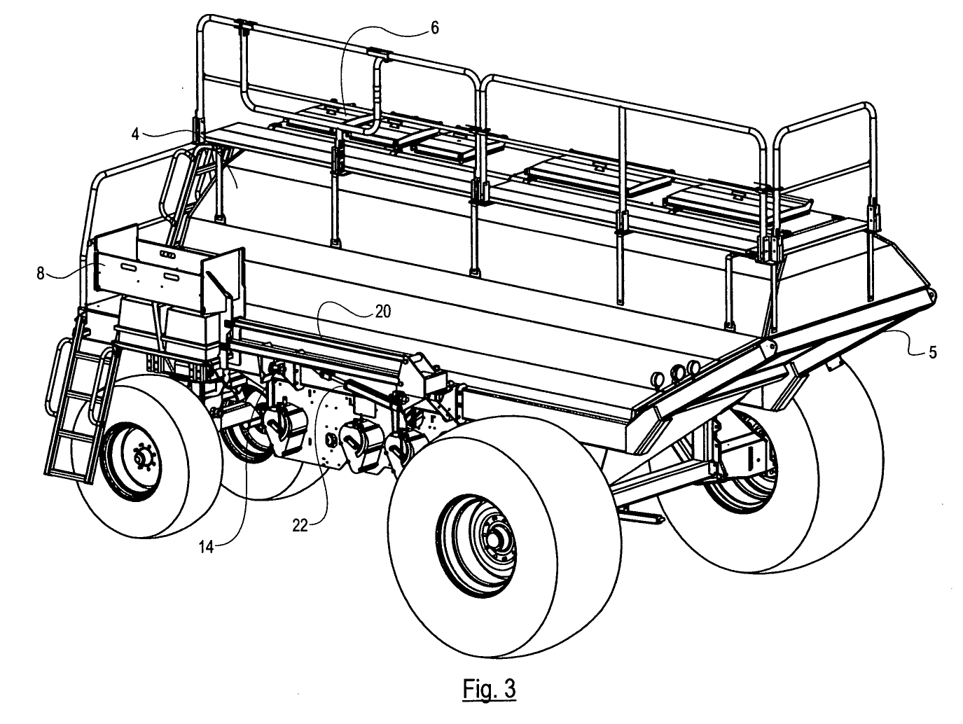

In the embodiment comprising the parallel arm assembly, a transport lock 14 is provided to selectively lock the platform 8 for transport of the cart 5 along the ground at an intermediate vertical position as illustrated in FIG. 3 that is between the lowered vertical position of FIG. 1 and the raised vertical position of FIG. 2.

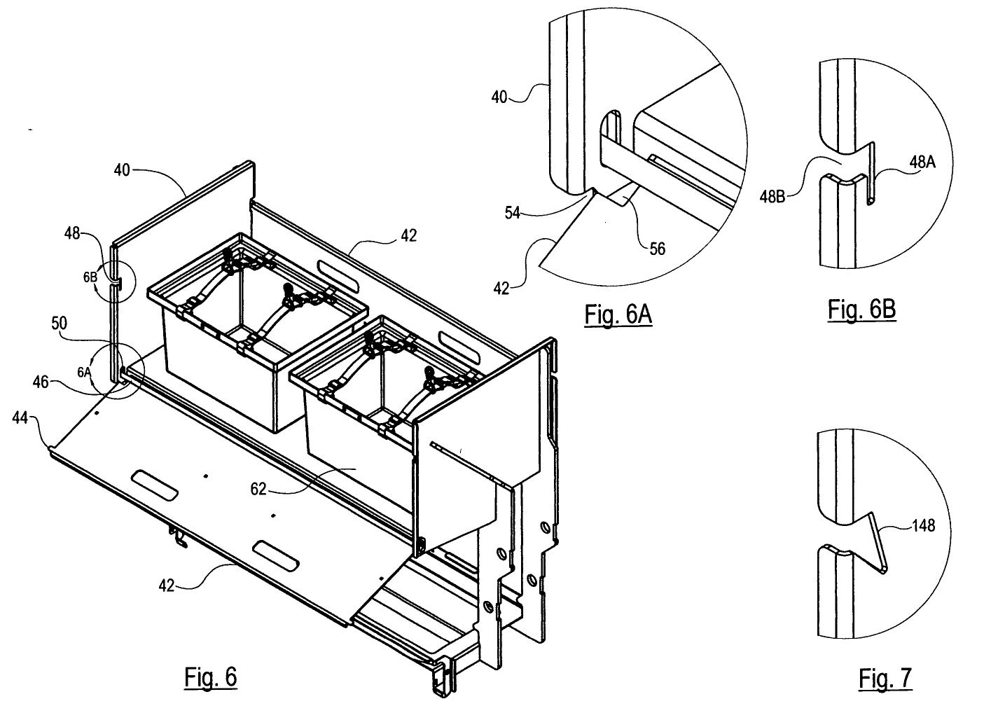

While the bags 12 could simply be placed on the platform 8, the illustrated embodiment further comprises end walls 40 and side walls 42 extending up from the platform 8 to form a box for more securely containing the bags 12 on the platform 8. The side walls 42 are pivotally attached such that they can be released to fold down from the upright position or removed as illustrated in FIGS. 6, 6A, and 6B to facilitate loading and unloading of containers.

The side walls 42 comprise upper pegs 44 and lower pegs 46 extending from each end thereof. The upper pegs 44 extend into corresponding upper slots 48 defined by the end walls 40 that extend upwardly and through the edges of the end walls 40. The lower pegs 46 extend into corresponding lower upright slots 50 defined by the end walls 40.

Thus gravity maintains the pegs 44, 46 at lower ends of the slots 48, 50 to maintain the side walls 42 in the upright position. Each side wall 42 can be lifted to move the upper pegs 44 up through the upper slots 48 to the edge of the side walls 40 and out of the upper slots 48 to allow the side wall 42 to fold down to facilitate loading and unloading the platform 8.

In the embodiment illustrated in FIGS. 6 and 6B, the end walls 40 define a substantially vertical slot portion 48A and a substantially horizontal slot portion 48B extending from a top end of each vertical slot portion 48A through the edge of the corresponding end wall 40.

Alternatively as illustrated in FIG. 7, the upper slot 148 can be oriented at an angle between the horizontal and vertical such that when the upper pegs 44 are at the bottom of the upper slot 148, the angle is such that the upper peg 44 resists horizontal movement, and when the side wall 42 is lifted, the upper pegs 44 move upward and outward along the upper slot 148 and out of the slot to be folded down.

The illustrated embodiment also provides a configuration facilitating easy removal of the side walls 42 if desired to accommodate raising a load that does not conveniently fit in the box.

As best illustrated in FIG. 6A, a bottom corner of the end wall 40 and a bottom corner of the end of the corresponding side wall 42 define release notches 54, 56 configured to align when the side wall 42 is folded down below a horizontal position as illustrated. With the release notches 54, 56 aligned, the side wall 42 can be moved toward the end wall 40 to release the lower peg 46 at the opposite end of the side wall 42 from engagement with the lower vertical slot 50 in the corresponding opposite end wall 40 such that the side wall 42 can be removed.

The lower pegs 46, slots 50, and release notches 54, 56 can be oriented to determine at a desired amount the angle below horizontal that is required to align the notches 54, 56 however it is contemplated that an angle greater than 15 degrees below the horizontal, and likely about 30 degrees will best provide convenient removal while preventing accidental removal.

In the illustrated embodiment, the platform 8 further comprises a lower storage compartment 60 under the platform 8 that is suitable for conveniently storing calibration boxes 62, as illustrated in FIG. 4. The illustrated calibration boxes 62 are shown stored upside down to prevent dust and the like from accumulating therein.

When reversing the conventional filling auger (not shown) to clean it for transfer of a different agricultural product, the cleaned out product may be caught in calibration box 62 or in a bag or like container and kept on the platform 8 for use at a later filling event, or the platform could be elevated to allow the operator to empty the cleaned out product into the appropriate tank 4. A tarp or like cover could be provided to cover the box formed by the end walls 40 and side walls 42 to protect such containers from weather and dust.

The transport lock 14, as best seen in FIG. 4, comprises a lock bracket 70 defining a pin hole 72 and a lock pin 74 mounted in a pin bracket 76 that is fixed to the cart 5 by bolts or the like. The lock pin 74 is mounted in the pin bracket 76 such that it is movable along its axis, and is biased in an outward direction OD by a spring 78. The lock pin 74 is moved in direction ID against the bias force and turned a partial rotation to engage a roll pin 77 extending through the lock pin in a shoulder 79 in the pin bracket 76 to secure the lock pin 74 in a disengaged position so that during operation the lock bracket 70 and pin bracket 76 can move past each other without engaging as the platform 8 moves up and down.

In the illustrated embodiment the lock bracket 70 is mounted on the inside of the lower arm 30 of the parallel arm assembly 20, and the pin 74 and pin bracket 76 are attached to the cart 5. Alternatively it is contemplated that the lock bracket 70 could instead be mounted on the cart 5, and the pin bracket 76 mounted on the parallel arm assembly 20.

The lock bracket 70 comprises a sloped portion 80 that bears against the lock pin 74 and pushes the lock pin 74 in an inward direction ID when the lock bracket 70 moves downward into contact with the end of the lock pin 74. When the lock bracket 70 has moved to an aligned position where the lock pin 74 and pin hole 72 are aligned, the lock pin 74 moves outward into the pin hole 72 in response to the bias force applied to it by the spring 78. Once inserted in the pin hole 72, the lock pin 74 keeps the platform locked at the intermediate vertical level illustrated in FIG. 3.

Thus to transport the cart, with the lock bracket 70 above the lock pin 74 the operator releases the lock pin 74 by turning it to disengage the roll pin 77 from the shoulder 79 and allow the lock pin 74 to move in direction OD in response to the bias force of the spring 78, and then operates the actuator control 82 to lower the parallel arm assembly 20 to engage the lock pin 74 in the pin hole 72.

The pin hole 72 in the illustrated embodiment is generally key-hole shaped, as illustrated in FIG. 5, and comprises a lower portion 72A that is significantly larger than the diameter of the lock pin 74, and an upper portion 72B that has a width substantially equal to the diameter of the lock pin 74. Lateral adjustment is provided on the fastening bolts and holes of the pin bracket 76, and on the bolts attaching the base bracket 24 to the cart bracket 26 attachment, for laterally aligning the lock pin 74 with the pin hole 72. Additionally, the key-hole shape of the pin hole 72 allows convenient and secure engagement without requiring precise alignment.

Initially, when the parallel arm assembly 20 and attached platform 8 move down, the sloped portion 80 of the lock bracket 70 pushes the lock pin 74 inwardly until it is aligned with the lower portion 72A of the pin hole 72. Since this lower portion 72A is significantly larger than the lock pin 74, precise alignment is not required for the lock pin 74 to align with and enter the lower portion 72A of the pin hole 72. As the operator moves the platform 8 further down, the lock pin 74 moves along the pin hole 72 from the lower portion 72A to the upper portion 72B, where it fits snugly and prevents the parallel arm assembly 20 from rattling and wearing the lock pin 74 and pin hole 72.

The lock pin 74 and lock bracket 70 are made strong enough to support the platform 8 and a plurality of bags 12 or other agricultural product containers. Thus added agricultural products can be carried with the air seeder on the platform 8 or in the storage compartment 60 under the platform 8. When verifying calibration, an operator may wish to dump only one or two bags into a tank and then, seed a corresponding number of acres before adding more bags to finish the field. By carrying more bags along with the air seeder, the operator can verify the calibration, and regardless of his location on the field when this task is completed, simply elevate the platform and dump more bags into the tank.

Similarly when finishing a field with the intention of changing a tank over to a different agricultural product upon completion, the operator will want to have a minimum amount of the present agricultural product left in the tank to clean out. Extra agricultural products can be carried on the platform 8 or storage compartment 60 in case the operator's estimate of the amount required to finish is short, allowing him to simply stop the air seeder and load in enough product to finish the field.

Similarly again, some agricultural products like inoculants begin to lose their effectiveness once the bag containing them is opened. The operator can then carry a few bags of inoculant with the air seeder and add them a few bags at a time to protect the potency of the inoculant should the seeding operation be unexpectedly halted for rain or a mechanical breakdown.

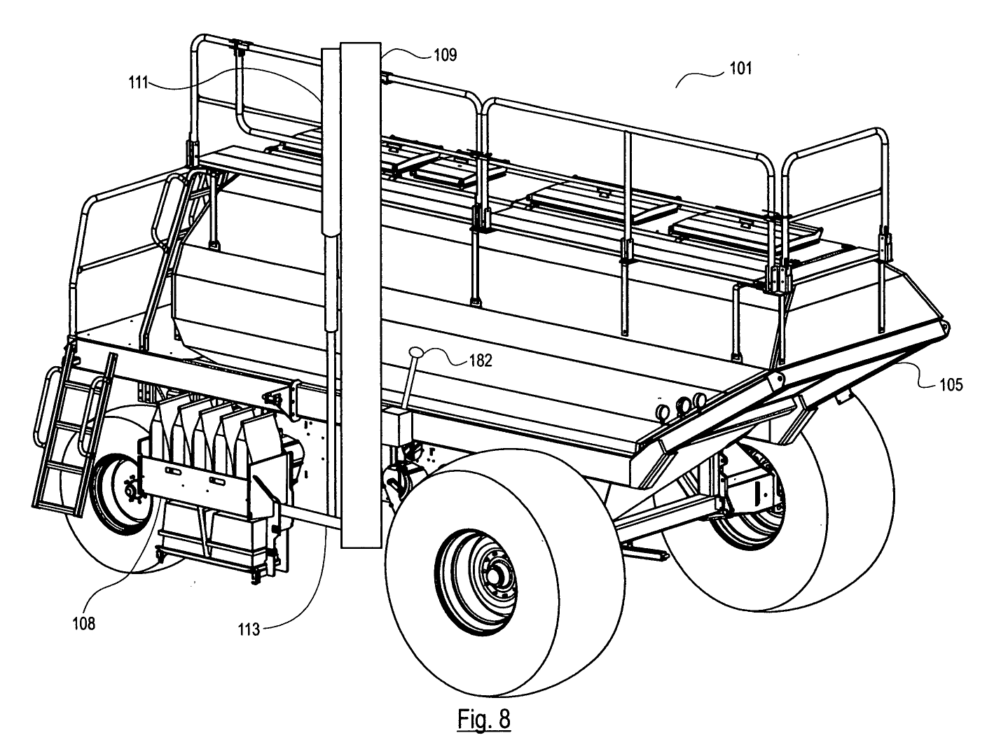

An alternate embodiment of the apparatus 101 of the present invention is illustrated in FIG. 8 where the raising mechanism 110 comprises a mast 109 attached to the cart 105 of the air seeder and oriented in an upright position and an actuator, illustrated as a hydraulic cylinder 111, mounted to the mast 109. A platform arm 113 is attached to the platform 108 and engages a channel in the mast 109 and the hydraulic cylinder 111 is attached to the platform arm 113. A control 182 extends and retracts the hydraulic cylinder 111 to raise and lower the platform 8. It is contemplated that other mechanisms, such as a chain and hydraulic cylinder as used in fork lifts could be provided in place of the hydraulic cylinder 111.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. An agricultural air seeder apparatus adapted for loading containers of agricultural products, the apparatus comprising:
an air seeder having at least one tank mounted thereon, the at least one tank having a top fill hatch for filling the tank with an agricultural product;
a platform adapted to carry a plurality of containers of agricultural product on a top surface thereof; and
a raising mechanism attached to the air seeder and the platform and operative to move the platform from a lowered vertical position to a raised vertical position adjacent to the top fill hatch while maintaining the platform in a substantially horizontal orientation;
wherein the raising mechanism is configured such that the platform is substantially prevented from moving laterally with respect to the tank.

2. The apparatus of claim 1 wherein the raising mechanism comprises a parallel arm assembly attached at a first end thereof to the air seeder and attached at an opposite second end thereof to the platform, and an extendable actuator pivotally attached to the air seeder and the arm assembly, and wherein the parallel arm assembly moves upward and downward in a substantially vertical plane such that the platform is substantially prevented from moving laterally with respect to the tank.

3. The apparatus of claim 2 wherein the parallel arm assembly comprises a first arm pivotally attached at opposite ends thereof to the air seeder and to the platform about substantially parallel and horizontal first axes, and a second arm pivotally attached at opposite ends thereof to the air seeder and the platform about substantially horizontal second axes located equal distances below and parallel to corresponding first axes, and wherein the extendable actuator is pivotally attached to at least one arm.

4. The apparatus of claim 3 wherein the first and second arms are pivotally attached to a base bracket, and wherein the base bracket is attached to the air seeder.

5. The apparatus of claim 4 wherein the base bracket is rigidly attached to the air seeder.

6. The apparatus of claim 2 further comprising a transport lock operative to selectively lock the platform at an intermediate vertical position between the lowered vertical position and the raised vertical position for transport of the air seeder along the ground.

7. The apparatus of claim 6 wherein the transport lock comprises a lock bracket defining a pin hole and mounted on one of the air seeder and the parallel arm assembly, and a lock pin mounted the other of the air seeder and the parallel arm assembly, and wherein the lock pin is inserted in the pin hole when the platform is locked at the intermediate vertical level.

8. The apparatus of claim 7 wherein the lock pin is mounted such that same is movable along its axis and the lock pin is biased in an outward direction, and wherein the lock bracket comprises a sloped portion operative to bear against the lock pin and push the lock pin in an inward direction as the lock bracket moves with respect to the pin, and when the lock bracket has moved to an aligned position where the lock pin and pin hole are aligned, the lock pin moves outward into the pin hole in response to a bias force.

9. The apparatus of claim 8 wherein the pin hole comprises a first portion larger than a diameter of the lock pin and a second portion having a width substantially equal to the diameter of the lock pin, and wherein when the platform moves down the pin moves along the pin hole from the first portion to the second portion.

10. The apparatus of claim 1 wherein the raising mechanism comprises a mast attached to the air seeder and oriented in an upright position, and an actuator mounted to the mast, and wherein the platform is attached to the actuator and engages the mast, and wherein the actuator is operative to move the platform from the lowered vertical position to the raised vertical position in a substantially vertical plane.

11. The apparatus of claim 10 wherein the actuator comprises a hydraulic cylinder.

12. The apparatus of claim 1 further comprising end walls and side walls extending up from the platform to form a box, and wherein the side walls are pivotally attached such that the side walls can be released to fold down from an upright position.

13. The apparatus of claim 12 wherein the side walls comprise:
lower pegs extending from each end thereof into corresponding substantially upright lower slots defined by the end walls; and
upper pegs extending from each end thereof into corresponding upper slots defined by the end walls and extending upwardly and through an edge of a corresponding end wall:
wherein gravity maintains the pegs at lower ends of the upper and lower slots to maintain the side walls in the upright position, and such that each side wall can be lifted such that the upper pegs move out of the upper slots to allow the side wall to fold down.

14. The apparatus of claim 13 wherein the upper slots comprise a substantially vertical slot portion and a substantially horizontal slot portion extending from a top end of each vertical slot portion through the edge of the corresponding end wall.

15. The apparatus of claim 14 wherein the upper slots are oriented on an angle such that a bottom of the upper slots is located inward from the edge of the corresponding side wall and the top of the upper slots passes through the edge of the corresponding side wall.

16. The apparatus of claim 13 wherein a bottom corner of a first end wall and a bottom corner of a first end of a corresponding first side wall are configured such that the first side wall can be folded down below a horizontal position and then moved toward the first end wall to release the lower peg at a second end of the first side wall from engagement with the lower vertical slot in an opposite second end wall such that the first side wall can be removed.

17. The apparatus of claim 16 further comprising release notches in the bottom corners of the first end wall and the first end of the first side wall.

18. The apparatus of claim 1 wherein the platform further comprises a lower storage compartment under the platform.

19. The apparatus of claim 18 further comprising calibration boxes stored in the lower storage compartment.

20. An agricultural air seeder cart apparatus adapted for loading bagged agricultural products, the apparatus comprising:
a cart having at least one tank mounted thereon, the tank having a top fill hatch for filling the tank with an agricultural product;
a platform adapted to carry a plurality of bags of agricultural product on a top surface thereof;
a parallel arm assembly pivotally attached at a first end thereof to the cart and pivotally attached at an opposite second end thereof to the platform;
an extendable actuator pivotally attached to the cart and pivotally attached to the arm assembly and operative to move the platform from a lowered vertical position to a raised vertical position adjacent to the top fill hatch in a substantially vertical plane such that the platform is substantially prevented from moving laterally with respect to the tank;
wherein the parallel arm assembly maintains the platform in a substantially horizontal orientation as the platform moves from the lowered vertical position to the raised vertical position.

21. The apparatus of claim 20 further comprising a transport lock operative to selectively lock the platform at an intermediate vertical position between the lowered vertical position and the raised vertical position for transport of the cart along the ground.

22. The apparatus of claim 20 wherein the parallel arm assembly comprises:
a base bracket rigidly attached to the cart;
an upper arm pivotally attached at opposite ends thereof to the base bracket and to the platform about substantially parallel and horizontal first axes;
a lower arm pivotally attached at opposite ends thereof to the base bracket and the platform about substantially horizontal second axes located equal distances below and parallel to the first axes;
wherein the extendable actuator is pivotally attached to the lower arm.

23. The apparatus of claim 20 further comprising end walls and side walls extending up from the platform to form a box, and wherein the side walls are pivotally attached such that the side walls can be released to fold down from an upright position.

24. The apparatus of claim 23 wherein the side walls comprise:
lower pegs extending from each end thereof into corresponding substantially upright lower slots defined by the end walls; and
upper pegs extending from each end thereof into corresponding upper slots defined by the end walls and extending upwardly and through an edge of a corresponding end wall:
wherein gravity maintains the pegs at lower ends of the upper and lower slots to maintain the side walls in the upright position, and such that each side wall can be lifted such that the upper pegs move out of the upper slots to allow the side wall to fold down.

25. The apparatus of claim 24 wherein the upper slots comprise a substantially vertical slot portion and a substantially horizontal slot portion extending from a top end of each vertical slot portion to the edge of the corresponding end wall.

26. The apparatus of claim 24 wherein the upper slots are oriented on an angle such that a bottom of the upper slots is located inward from the edge of the corresponding side wall and the top of the upper slots passes through the edge of the corresponding side wall.

27. The apparatus of claim 24 wherein a bottom corner of a first end wall and a bottom corner of a first end of a corresponding first side wall define release notches configured to align when the first side wall is folded down at least fifteen degrees below a horizontal position, such that the first side wall can then be moved toward the first end wall to release the lower peg at a second end of the first side wall from engagement with the lower vertical slot in an opposite second end wall such that the first side wall can be removed.

28. The apparatus of claim 20 wherein the platform further comprises a lower storage compartment under the platform.

29. The apparatus of claim 28 further comprising calibration boxes stored in the lower storage compartment.

30. The apparatus of claim 21 wherein the transport lock comprises a lock bracket defining a pin hole and mounted on one of the cart and the parallel arm assembly, and a lock pin mounted the other of the air seeder and the parallel arm assembly, and wherein the lock pin is inserted in the pin hole when the platform is locked at the intermediate vertical level.

31. The apparatus of claim 30 wherein the lock pin is mounted such that same is movable along its axis and the lock pin is biased in an outward direction, and wherein the lock bracket comprises a sloped portion operative to bear against the lock pin and push the lock pin in an inward direction when the lock bracket moves downward into contact with the lock pin, and when the lock bracket has moved to an aligned position where the lock pin and pin hole are aligned, the lock pin moves outward into the pin hole in response to a bias force.

32. The apparatus of claim 31 wherein the pin hole comprises a first portion larger than a diameter of the lock pin and a second portion having a width substantially equal to the diameter of the lock pin, and wherein when the platform moves down the pin moves along the pin hole from the first portion to the second portion.
